(19) United States
(12) Patent Application Publication
(10) Pub. No.: US 2024/0054558 A1
(43) Pub. Date: Feb. 15, 2024

(54) SYSTEM AND METHOD FOR AN INTERACTION INTERFACE FOR COLLECTION OF RESPONSES TO GENERATE PREFERRED OFFERS

(71) Applicant: LoanCraft, LLC, Troy, MI (US)

(72) Inventor: Ronald Frederick George, Troy, MI (US)

(21) Appl. No.: 18/447,937

(22) Filed: Aug. 10, 2023

Related U.S. Application Data
(60) Provisional application No. 63/396,809, filed on Aug. 10, 2022.

(51) Int. Cl. G06Q 40/03

(52) U.S. Cl. CPC G06Q 40/03

(57) ABSTRACT

A system and method for evaluating and recommending financial products such as loans for a customer is disclosed. The system includes a question set manager generating a set of interfaces to display questions related to financial needs of the customer. A question set manager collects answers to the questions. Available financial programs each having a set of pricing parameters are stored. An analysis engine determines a desirability score for each of the financial programs determined by the collected answers to the displayed questions in relation to the pricing parameters. A recommendation engine outputs a ranking of financial products by the determined score.

### TECHNICAL FIELD

This disclosure claims priority to and the benefit of U.S. Provisional Application No. 63/396,809, filed Aug. 10, 2022. The contents of that application in their entirety are hereby incorporated by reference.

### TECHNICAL FIELD

The present invention relates generally to determining appropriate financial programs, and more particularly, to an application programming interface that allows communication of data to determine desirability scores for loan products based on program parameters and customer input from multiple device types.

### BACKGROUND

Traditionally, consumers seeking loans have consulted financial institution employees such as loan officers. The consumer will receive information about available loan products from the loan officer. As the population shifts to online interaction with banks and lenders, the loan sales and application process has shifted online as well. However, humans have traditionally been much better than computer systems at explaining and marketing consumer loans. Online systems have focused on the processing of loans such as the collection of information and documents necessary to fulfil loan applications into closed loans. Humans can ask customers about their goals and objectives, make loan offers to the customer that fit these, and then explain to the customer why the offers fit their needs. Automated systems generally do not ask good questions about the goals and objectives of customers, and do not do a good job of finding offers that suit them. Further, lenders often work with entrenched systems for decades and find wholesale change of these systems to be very difficult. Finally, modern lending requires scale and efficiency, and it has become increasingly difficult to recruit, hire, train, and retain loan officers and other personnel to serve customers, while meeting regulatory requirements.

Thus, there is a need for an automated system that can collect data relating to goal and objective oriented questions from customers for financial products. There is also a need for an automated system that can determine appropriate financial products to a consumer and provide a recommendation to the consumer. There is also a need for a tool that allows interface to different applications from different financial institutions.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One example is a system evaluating and recommending financial products for a customer. A question set manager generates a plurality of questions related to financial needs of the customer and collects answers to the plurality of questions. A memory stores a plurality of financial products. Each of the financial products has a set of parameters. An analysis engine determines a desirability score for each of the plurality of financial products determined by the collected answers to the displayed questions in relation to the parameters. A recommendation engine outputs a ranking of the plurality of financial products by the determined score.

In another disclosed implementation of the example system, the system includes an application programing interface (API) allowing interface to a computing device operated by the consumer. The API allows interface to different devices and operating systems. In another disclosed implementation, the API allows access to an application executed on the computing device to display the questions on the device. In another disclosed implementation, the recommendation engine outputs a recommendation based on the ranking of the plurality of financial products. In another disclosed implementation, the recommendation engine outputs an explanation of the recommended products. In another disclosed implementation, the application presents the plurality of questions as a single display of the questions. In another disclosed implementation, the application presents each of the plurality of questions singularly. When an answer is received the next question to be displayed is allowed. In another disclosed implementation, the application displays an input to allow an application for the recommended financial product. In another disclosed implementation, the financial products are loan programs and the parameters include interest rate and income.

Another example method to evaluate and recommend financial products for a customer is disclosed. A set of interfaces is generated to receive a plurality of questions related to financial needs of the customer and collect answers to the plurality of questions. A plurality of financial products is stored. Each of the financial products has a set of parameters. A desirability score is determined for each of the plurality of financial products determined by the collected answers to the displayed questions in relation to the parameters. A ranking of the plurality of financial products by the determined score is output.

In another disclosed implementation of the example method, an application programing interface (API) interfaces to a computing device operated by the consumer. The API allows interface to different devices and operating systems. In another disclosed implementation, the example method includes accessing an application executed on the computing device to present the questions on the device. In another disclosed implementation, the example method includes outputting a recommendation based on the ranking of the plurality of financial products. In another disclosed implementation, the example method includes outputting an explanation of the recommended products. In another disclosed implementation, the application presents the plurality of questions as a single display of the questions. In another disclosed implementation, the application presents each of the plurality of questions singularly. When an answer is received, it allows the next question to be displayed. In another disclosed implementation, the application displays an input to allow an application for the recommended financial product. In another disclosed implementation, the financial products are loan programs and the parameters include interest rate and income.

Another disclosed example is a non-transitory computer-readable medium having machine-readable instructions stored thereon, which when executed by a processor, cause the processor to generate a set of interfaces to display a plurality of questions related to financial needs of the customer and collect answers to the plurality of questions. The instructions cause a plurality of financial products to be stored. Each of the financial products has a set of parameters. The instructions cause the processor to determine a desirability score for each of the plurality of financial products determined by the collected answers to the displayed questions in relation to the parameters. The instructions cause the processor to output a ranking of the plurality of financial products by the determined score.

In another disclosed implementation of the example non-transitory computer-readable medium, the machine-readable instructions are an application programing interface (API) allows interface to different devices and operating systems.

### BRIEF DESCRIPTION OF DRAWINGS

In order to describe the manner in which the above-recited disclosure and its advantages and features can be obtained, a more particular description of the principles described above will be rendered by reference to specific examples illustrated in the appended drawings. These drawings depict only example aspects of the disclosure, and are therefore not to be considered as limiting of its scope. These principles are described and explained with additional specificity and detail through the use of the following drawings:

FIG. 1 shows an example system that allows the adaptive interaction with consumers via different devices for providing a tailored recommendation;

FIG. 2 shows a process diagram of the system in FIG. 1 for automatically collecting consumer information and returning a recommended financial product;

FIG. 3 shows a set of transactions for an example API in the system in FIG. 1;

FIGS. 4A-4B are a screen shot of an interface that allows selection of questions for selection of a financial product by the API in FIG. 1;

FIG. 5A-5B is an inventory of questions that may be selected through the interface in FIG. 4;

FIG. 6 shows a screen shot of a display interface that includes recommended financial products and informational outputs generated by the system in FIG. 1; and

FIGS. 7-8 are diagrams of example computer systems for the system in FIG. 1.

### DETAILED DESCRIPTION

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials specifically described.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The present disclosure relates to a determining appropriate financial programs, and more particularly, to a system that determines desirability scores for loan programs based on program parameters and customer input. After considering a variety of options, the system provides a consultative, tailored recommendation about those options to the consumer through an API that may be tailored to different applications.

The advantages of the disclosed method and system are determining both goal and objective oriented data through tailoring questions to the customer interface. The example system translates the consumer responses to quantifiable dimensions that can be used to rate and score offers for different financial products. The example system generates and scores a wide range of offers that meet the needs of the customer as well as any other constraints. The example system communicates the options that most fit the customer needs to the customer and explains the reasons why the offers best fit their needs. Finally, since the interface is an API, the system offers a wide set of alternatives for integrating into the existing lender system infrastructure that may be accessed by developers.

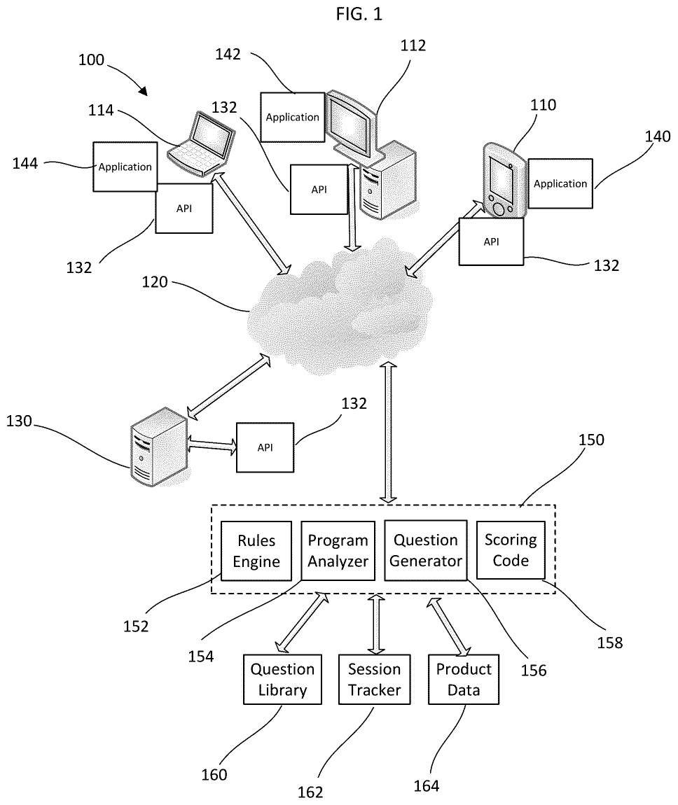

FIG. 1 shows an example financial services environment 100 that allows a system to provide automated financial product recommendations for different customers. The customers may operate different types of user devices such as a mobile device 110, a work station 112, or a lap top computer 114. Each of the devices 110, 112, and 114 have a network interface that allows communication with the Internet 120 or a Cloud based network. The devices 110, 112, and 114 may run different applications on different operating systems. Each of the devices 110, 112, and 114 may also access different financial infrastructure offered by financial institutions that offer different financial products.

An API server 130 allows each of the devices 110, 112, and 114 to access and download an API 132. Once the API 132 is installed on a device such as any of the devices 110, 112, and 114, the API 132 allows interaction with a customer through existing infrastructure offered through the devices from a financial institution. The uniqueness of the API solution is that it allows the process to be distributed through a wide variety of user interfaces, including phones, web sites, proprietary systems, or any system which can access an API via the internet. In this example, each of the customers may operate applications running on diverse operating systems offered by different financial institutions. For example, the mobile device 110 may have a specific application 140 that is offered by a first financial institution and operates on a mobile operating system. The personal computer 112 may have another specific application 142 offered by a second, different financial institution that operates on another type of operating system. The laptop 114 may have a third application 144 offered by a third, different financial institution that operates on yet another operating system. The developers of the applications 140, 142, and 144 may each access the API 132 and develop features that access the features of automatic recommendation of financial products through the API 132.

The API 132 is built on an API foundation, so that its features can be integrated within other front ends or user interfaces that are offered by other developers. As will be explained, the API 132 supplies questions one at a time, or in groups, to the front-end interface. The API 132 communicates the answers to the questions to the application server to provide the recommendation data relating to a financial product to the front-end interface. The front-end interface can display the recommendations in various ways to the customer or loan officer using the specific application.

The API 132 thus allows the devices 110, 112, and 114 to communicate through the Internet 120 with an application server 150. The application server 150 includes a rules engine 152, a program analyzer module 154, a question generator module 156, and a scoring code module 158. The application server 150 accesses different databases including a question library 160, a session tracker 162, and a product database 164. The interaction accesses the application server 150 to execute generation of questions for the consumer for the API 132. The modules 152, 154, 156 and 158 of the application server 150 track responses, use pricing engine technology to generate collections of potential offers, generate preference dimensions from consumer responses, scores the various offers according to the preference dimensions, provide rankings of offers based on scores, generate English language recommendations for the consumer, and provide “conditions” or “stipulations” to assist in the handling of transactions.

The API 132 provides a secure API interface for transacting with different devices and different operating systems that have different libraries for accessing APIs. The API 132 includes secure authentication protocols for the transactions. In this example, the API 132 allows execution of transactions between a device and the application server 150. The transactions include initiating a session, getting the next question, providing an answer to the last question, generating offers, scoring offers, obtaining a ranked list of offers, and obtaining a recommendation using an audio prompt. The recommendation may thus access the language of applications on the device such as an English audio response.

The rules engine 152 is executed by a processor and includes code to generate and analyze available offers for a user. The rules engine 152 first determines which product offers the consumer is eligible for. Eligibility is based on multiple parameters such as FICO scores, loan amount, type of property, state, county, value of property, ratio of loan to value. The rules engine 152 includes a routine of pricing rules. Loan pricing contains adjustors based on the variety of inputs that are used. Pricing connects to the interest rate offered to the borrower, and is affected by FICO scores, state, loan to value, existing relationships, property type (e.g., mobile homes get higher rates), occupancy type, (e.g., investment homes get higher rates), etc. The rules engine 152 also includes a routine of eligibility rules. Particular programs have different eligibility rules. For example, a program might not be available in a particular state. Another example is a program that is not available for loans that are above a particular loan to value. One example is a loan that excludes situations where the loan to value is above 80%. If the answer inputs include a loan amount of $400,000, and the property value is less than $500,000, then the loan to value exceeds 80% and the consumer is not eligible for the loan. In a particular situation, a variety of programs and potential loan amounts need to be analyzed quickly to be useful. Thus, the system also seeks possible offers. For the above example, if the property value is only $450,000, then a max loan amount of $360,000 would apply, and the system would find that program.

The question generator 156 includes a processor that executes code to generates questions for display by the API 132 based on previous questions and other data. Thus, the question generator 156 includes code that allows a processor to track responses received by the API 132 to questions as well as code that allows the processor to determine the next question to be displayed by the API 132 to the customer. The code also allows a wide variety of questions that may be added. Questions that are added must be matched to dimensions that affect recommendations.

The scoring module 158 is executed on a processor to generate scores and recommendations for the customer. The scoring module 158 includes code that when executed by a processor assigns score values to various scoring dimensions that determine importance of each dimension to the consumer. Scoring dimensions may include lowest fees, lowest cost, lowest rate, most flexibility, most stability, and ability to meet needs for cash. The importance is determined from the input from the consumer from the API 132. For example, suppose a customer indicates that they might move in the next three years. They will get less value from obtaining a fixed rate loan. A fixed rate loan is often more expensive than a variable rate loan, because loan pricing reflects financial markets, and financial markets assign a risk premium to promising rate stability. The longer the time period of fixed rate, the more the potential cost. If one plans to move in three years or less, then then they will not derive as much benefit from fixing the rate as they would if they didn't move, since when they move, they will be required to pay off the loan. So the system will give more points to variable loans in this case, and fewer points to fixed loans. The scoring module 158 also includes code that assigns score values to various scoring dimensions for the offers. Questions are connected to scoring dimensions, and thus identify the particular importance of the scoring dimension to the customer. For example, one of the scoring dimensions might be Fees, and the questions help identify an importance level for fees for the customer. Either directly or indirectly, questions serve to raise or lower the importance of low fees. When various offers are compared, those that have lower fees are given greater recommendation points for those whose questions have led to higher scores for the “Fee” dimension. A more sophisticated question may determine the risk aversion of the customer by asking them whether they feel comfortable about their current sources of income. If a customer is confident in their future income, they should be more comfortable with programs that have variable rates. Thus, the “Variability” dimension is given more positive points if the customer is less risk averse.

The scoring module 158 also includes code to rank and produce a list of offers based on scoring dimensions. The transaction can return all available offers, or some smaller number of offers. The list includes the terms of the offer, which includes the loan amount, interest rate, term, payment, timing of potential variation in the rates, lender and other elements. In addition, the recommendation score is included. The API 132 provides sufficient data so that the client system has a variety of options. The client system application may be programmed to present only the most highly scored offer or present a number of top offers. The scoring module 158 in this example also includes a recommendation explanation generator to provide information relating to recommendations based on the inputs. The generator generates language that explains why the offer is preferred or recommended (or not recommended). The client system may be programmed to display the recommendation explanation. The recommendation itself explains the way that the scoring dimension and terms impact the recommendation. For example, if an offer is favored because it has lower fees, and the answers to the question indicate that lower fees are important to them, the explanation of the recommendation will include this information.

In this example, the question library 160 includes a catalog of various questions with attributes for different dimensions. For example, an attribute in a question for lowest fees would be linked to scoring dimension that provides higher scores for products with lower fees. Other examples of scoring dimensions are fees, rates, variability, overall cost, risk, and flexibility. The questions are indexed by dimension and thus may be accessed by the server 150 in response to responses received by the API 132 based on a sequence of questions.

The question library 160 also includes an editor for creation and maintenance of the questions. An editor application accessible on the server 150 include attributes for question content, question style, and impact of the question on scoring dimensions that may be selected by a developer. Question sets are available from an API transaction which obtains a list of available questions and there is also an Internet application provided by the application server 150 that provides a screen to add or subtract existing questions from question sets. The editor application thus allows a developer to modify different questions in the question library 160. The question library 160 also includes an editor application for creation and maintenance of “question groups” which are sets of questions. For example, a financial institution may wish to try two different groups of questions to see which leads to more interest or business from its customers. From the library of questions, the developer might create Set A and Set B of questions, and then using some criteria, the developer might use Set A 45% of the time and Set B 55% of the time.

The session tracker 162 is a database that stores information that is tracked for each session with the API 132 such as the response by users. When a consumer begins a session, the client system notifies the API 132. The session contains all the interactions between consumer and the system. This allows the API 132 to present the next question to the client system. The session tracker database 162 contains the questions that are being asked in the session, and all of the answers provided so far. This allows for a stateless interaction with the API.

The session tracker database 162 may also include rule sets for determining eligibility and pricing. The product database 164 includes data fields that create a profile for a particular loan program, including the lender, the term, does it have a prepayment penalty, is it a Freddie Mac or Fannie Mae program, does it have a variable rate, if so, how often does the rate adjust, etc.

The system 100 may be adapted for diverse platforms operated by a financial institution. For example, a bank may have front end interfaces on devices that branch associates use. The front end interfaces are programed to set a question sequence in response to a customer inquiry. The device initiates a session to the API 132. The API 132 accesses the application server 150 and feeds questions to the interface. The interface on the device collects the answers to the questions and sends the answers to the API 132 for transmission to the application server 150. When the question list is finished, the API 132 executed by the application server 150 analyzes all of the available products for the customer, and scores them, using the scoring dimensions. The importance of the various scoring dimensions is calculated based on the answers to the questions as explained above. The API 132 then returns a ranked list of products available to the customer, along with a recommendation. The example interface generated by the data from the API 132 via the application presents the list of offers to the screen, and the branch associate may show the list to the consumer with whom they are working. Alternatively, the interface may offer other outputs such as a printed summary or electronic transmission to a device operated by the customer. The explanation of the recommendation based on the scoring dimensions derived from the answers to the questions may also be displayed.

Another example may be for a mortgage company that may have a proprietary mobile device application which can gather answers to questions and provide information to consumers. The proprietary application may be set to query the API 132 and provide the returned recommendation. In this example, the mobile device initiates the session through the API 132. The API 132 tracks the session. The API 132 supplies the questions to the mobile device application based on the collected information analyzed by the application server 150. The mobile device application thus displays the question, gets the answer, and sends the answer to the API 132. The API 132 then sends the next question as determined by the application server 150. This process continues until the question set is complete. The API 132 then analyzes all of the available mortgage programs for the customer, and scores them, using scoring dimensions. The importance of the various scoring dimensions is calculated based on the answers to the questions by the consumer. The API 132 then returns a ranked list of programs, along with an explanation of the recommendation. The mobile device application may be configured to use the top 3 mortgage programs in this example. The application may also deliver a voice generated communication of the recommendation explanation, using the text data supplied by the API 132.

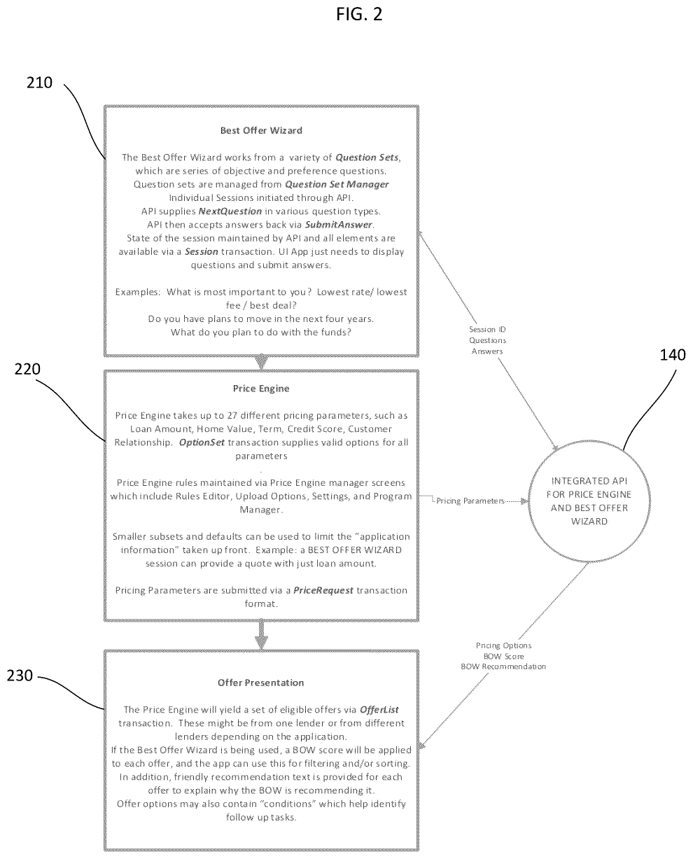

FIG. 2 is a process diagram showing the interaction between the API 132, the application server 150, and the application running on the device operated by a user. In a question and answer phase 210, the API 132 accesses the question generator 156 to present question sets on the device application to the user. The question sets may be a series of objective questions and preference questions to determine attributes from the consumer. The question sets are managed from a question set manager that operates the question library 160. The API 132 supplies the next question in the selected question sets. The API 132 interfaces with the device application to accept answers. The state of the session is maintained by the API 132 and all elements are available via a session transaction command. The device application communicates with the API 132 to display the questions and retrieve the answers.

A pricing phrase 220 determines pricing parameters. In this example, the pricing engine of the rules engine 152 obtains different pricing parameters such as loan amount, home value, term, credit score, customer relationship. The parameters are coming either from questions or inputs presented to the consumer and collected by the client system, or may be set as default values. The option set transaction supplies valid options for all the parameters. The option set identifies valid responses for the various elements. For example, valid values for answers to the property type question include Single Family Residential, Multi-Family Residential, Mobile Home, Modular Home.

The option set transaction would contain, for the section related to Property Type, the list identified above. This means that the API is supplying to the client a list of valid values that it might present to the consumer in a drop down list or some other UI component, and allows the client to anticipate and prevent validity errors when submitting data. The price engine rules are maintained by a price engine manger that includes a rules editor, upload options, settings and a program manager. The price engine manager includes sets and subsets of rules that determine eligibility, price, fees, and can also identify conditions. An example of a price engine manager is the LoanCraft PPE available from LoanCraft. Smaller subsets of questions and defaults may be used to limit the information obtained by the API 132. The pricing parameters are sent to the application server 150.

The application server 150 through the modules 152, 154, 156, and 158 in FIG. 1 determines pricing options, the score of the options, and the recommendations. The options, scores, and recommendations are sent to the API 132. The API then performs an offer presentation 230. The presentation may include a set of eligible offers to the consumer. The offers may include product offers from one lender or different lenders depending on the application. The API transactions to get offers include parameters that can be set to specify particular lenders, or all lenders which identify the subsets of lenders that will be consider. To be a valid eligible lender, the lender must be contained in the load Program or Product Data that is stored in the rules engine 152. The score for each program is calculated based on the answers to the preference questions. The calculated score is applied to each offer. The offer presentation includes information text for each offer and reasons for the recommendations. The offer options may also include other information such as the conditions or follow up tasks for the customer.

Developers of device applications such as the device applications 140, 142, and 144 in FIG. 1 may write scripts to access the API 132 for collecting customer preference data and returning offer recommendations. A script thus may include four steps: 1) initiating a customer session; 2) presenting questions and collecting answers; 3) obtaining and presenting offers; and 4) presenting and managing calls to action. Each of the steps involves specific transactions with the API 132.

For initiating a session, the API 132 has an authentication transaction. In this example, authorization to access the API 132 may be obtained by using Oauth authentication, which includes client id and client secret. Other types of authentication may be used. The OAUTH key may be used in the header for subsequent transactions with the API 132. The defaults for the API 132 may be set or existing parameter defaults may be used. Defaults are for the various underwriting parameters that are used to determine eligibility and pricing. For example, it is possible that a financial institution wishes to assume that all customers have an income of $10,000 a month. The financial institution may make the offers based on this assumption and will obtain and verify the income amount from the customer later. Then they will use these defaults to set the income at $10,000.

The initiation of a session requires obtaining a session ID and a question set. In this example, there are three options for obtaining a question set. First, a developer may specify the product type and a question set is selected based on the criteria set in the question set editor screen. For example, a financial institution might design a question set that is particularly well suited to a Home Equity Line of Credit loan product, but not for a mortgage used to purchase a home. In that case, the question set might first ask a customer which kind of loan they were seeking, and then use the appropriate question set. There might be other cases where it is relevant to consider both type of programs, and then a different question set might be used. Second, a developer may identify a question set by ID number. ID numbers and corresponding question sets may be found in a question set editor screen. Depending on the range of programs and ideas about the best way to work with customers, guided by their judgment and data, the financial institution may create and deploy several different question sets. A client might also wish to sometimes use a 5-question set, which might lead to more consumer participation but less precision in the recommendation versus a 15-question set, which might lead to some loss of consumer interest, but better quality recommendations. The client may wish to deploy environments where both approaches are used and the API 132 facilitates this. Finally, a developer may specify the exact list and order of questions by specifying an array within the initiate session transaction with the API 132. For example, an exact list may be developed using the transactions which specify the list of questions as part of their parameters.

The next step is presenting questions and collecting answers. A developer may chose between sequential and whole question set modes that are executed by the API 132. The sequential mode displays a single question and on receiving the answer will display the next question. The whole question set mode displays all of the questions in a set and answers are saved when available or at the closing point of the session.

The next step is getting and presenting offers. Once a question set is initiated, offers may be obtained through a command by the API 132 with a session ID. The answers to the questions provide additional values and/or information about scoring dimensions that will affect the offers or the scoring of the offers. The GetOffers transaction allows a developer to specify the set of “lenders” that will be queried for the production of offers. The GetOffers transaction yields an OfferList, which includes offer terms, offer score, and recommendations for each offer that are determined by the application server 140. The developer may select one or more rows from this list and present a single best offer, or some form of a list of available offers to the application.

The last step is identifying and handling calls to action. The API 132 allows access to different communication such as chat, email, phone for a proposal and applicable application for the offer. The communication may be integrated into internal computer systems maintained by the financial institution.

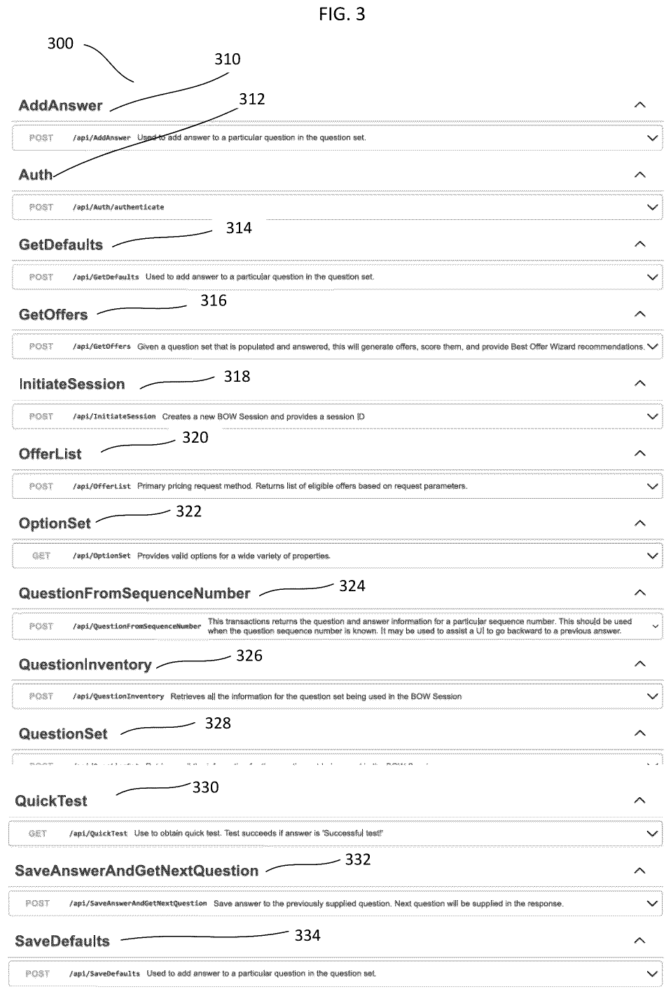

FIG. 3 shows a list of transactions 300 for the API 132 that may be available to a developer for initiating the steps described above. The transactions include an Add answer 310 that is used to add an answer to particular question in the question set. An Auth transaction 312 is used to authenticate the session. A GetDefaults transaction 314 is used to allows the financial institution to obtain the default answer for various application parameters. For example, if the financial institution is using a default FICO score of 700, that would be obtained from the response to this transaction. A GetOffers transaction 316 will generate offers and corresponding scores and obtain the recommendation from the application server 140. An Initiate session transaction 318 creates a new session with a customer and assigns an ID to the new session. An OfferList transaction 320 returns lists eligible offers based on request parameters. An OptionSet transaction 322 provides provides valid values for various application parameters such as Property Type or Occupancy Type. A Question from sequence number transaction 324 allows a user interface to return a question for a particular sequence number. A QuestionInventory transaction 326 retrieves information for all questions that could be used in a session. A QuestionSet transaction 328 retrieves all the information for a question set being used in a session. A QuickTest transaction 330 allows a test to be conducted of a simple transaction that can be used by the client to test their connectivity and access to the endpoint. It allows them to confirm they can access the endpoint—any errors would be related to access rather than to data they are submitting. A Save Answer and Get Next Question transaction 332 saves the answer of the current question and displays the next question in a sequence. A SaveDefaults 334 transaction updates the list of default values that are applied to the application parameters. If a financial institution wants to assume the FICO scores of customer are 700, but later decides to use 720, the SaveDefaults transaction is used to update the default value for FICO.

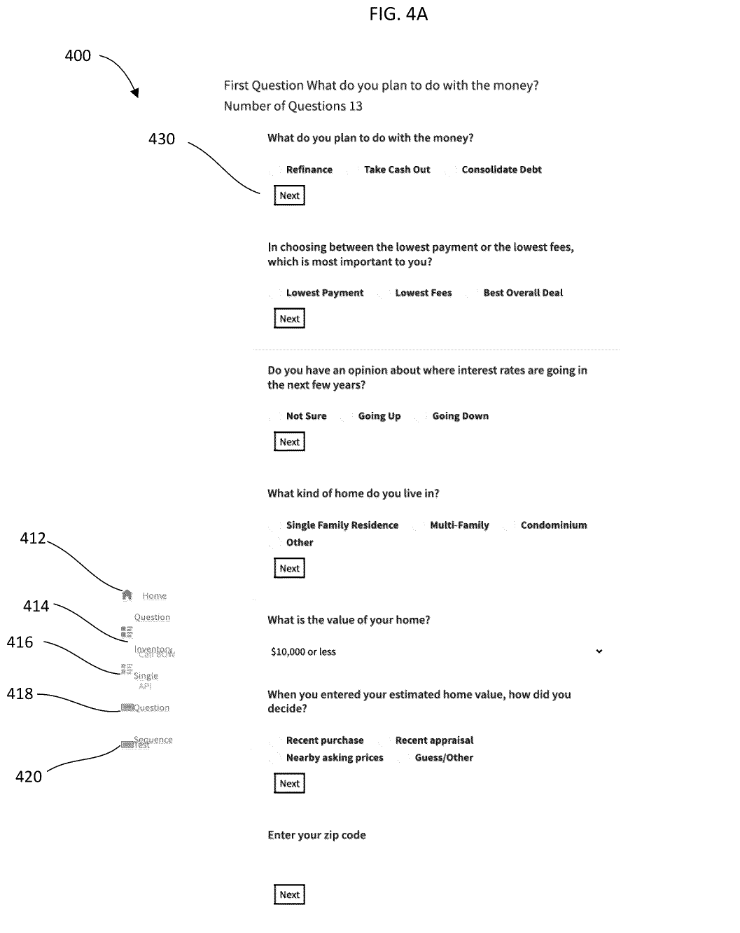

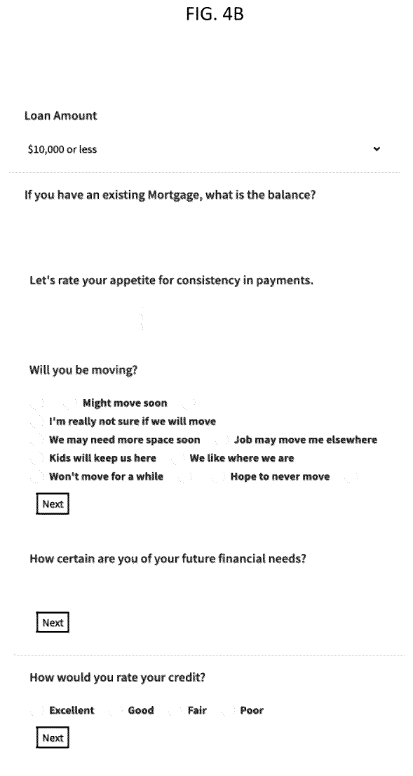

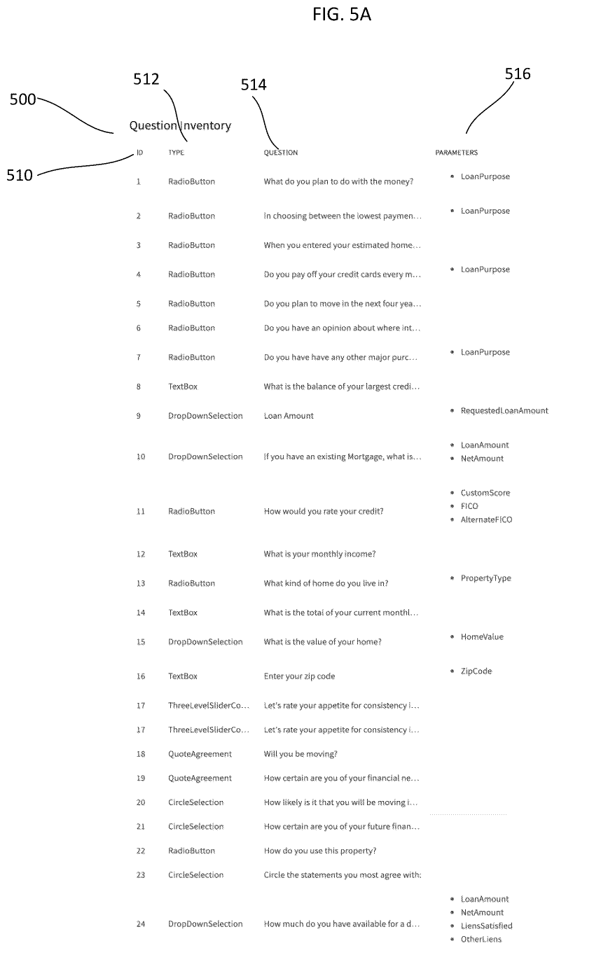

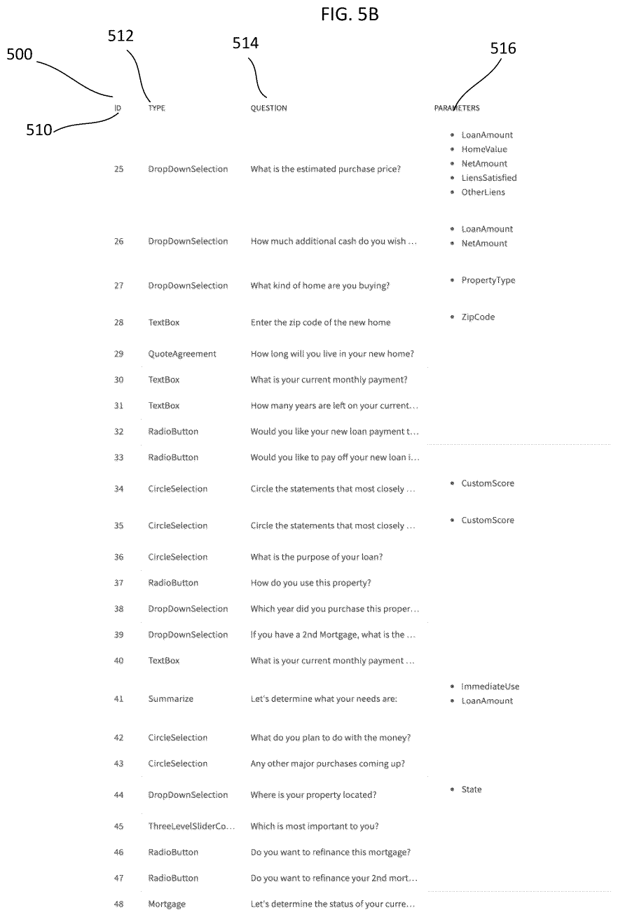

FIGS. 4A and 4B show an example interface 400 generated for interfacing an application to the API 132 based on questions generated by the question generator accessing an inventory such as shown in FIGS. 5A-5B. The interface 400 includes different function selections that include a home selection 410, an inventory selection 412, a single API selection 414, a question selection 416, and a sequence test selection 418. Each of the function selections initiates different tests or documentation.

A workplace area 430 shows a series of questions 432 that have been generated through the interface 400. Each of the questions are sent by the API 132 interfacing with the existing application on the user device. The questions are selected from the question set sent by the API 132 by ID number or the next question in sequence. Each of the questions includes a next button that will display the next question once an answer is input. Certain questions such as a question relating to the kind of home owned use radio buttons for the answer. Other questions such as question relating to a desired loan amount use a dropdown menu. Other questions such as the question relating to zip code use a text box for entry of data by the user.

FIGS. 5A and 5B are an example inventory 500 of attributes of questions that may be assembled and made available by the question generator 156 in FIG. 1. The questions in the inventory 500 are made available to a developer to select different questions for the question generator 156. The inventory 500 includes an identification column 510, a type column 512, a question text column 514, and a parameters columns 516. The identification column 510 includes the ID of the specific question. The type column 512 indicates the corresponding method of gathering an answer. The types may include a radio button, a text box, a selection from a dropdown menu or other methods of gathering an answer. The question text column 514 lists the actual question. The parameters column 516 list the application parameters that the question is directed toward. As explained above, the answers to different parameters listed in the parameters column 516 determine both the recommended products as well as the score of the recommended products.

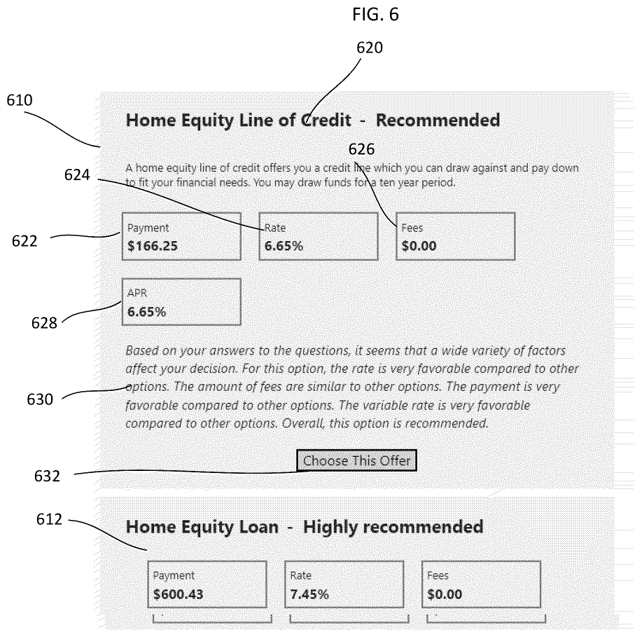

FIG. 6 shows a screen image of an example display of results 600 that is generated using information obtained through the API 312 by an application executed on the specific user device in FIG. 1. In this example, the API 132 has returned different options of loan products based on loan amount, state, and purchase price of home. The application on the specific user device has generated the display 600 to includes two recommendation areas 610 and 612. The first recommendation area 610 includes a summary of a loan 620 that is labeled as recommended. Parameters of the recommendation are listed such as a payment field 622, a rate field 624, a fees field 624, and an APR field 628. The parameters are taken from the product database 164 in FIG. 1 once the recommended product is returned by the modules of the application server 150.

An explanation field 630 is populated by information relating to the recommended loan 620 based on the values relevant to the parameters and the explanation provided relating to the parameters. This information is provided by the API 132 and formatted by the application executed by the user device. The example interface 600 also includes a selection 632 that allows the application to access other financial services such as a load application program that allows the customer to apply for the loan 620.

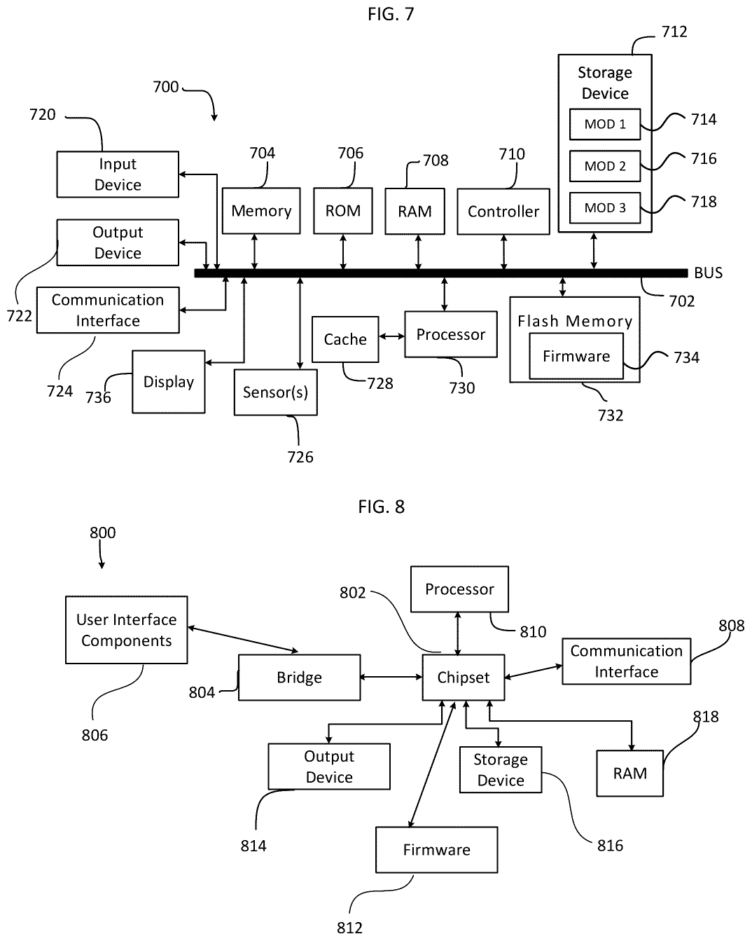

FIG. 7 illustrates an example computing system 700, in which the components of the computing system are in electrical communication with each other using a bus 702. The system 700 includes a processing unit (CPU or processor) 730, and a system bus 702 that couples various system components, including the system memory 704 (e.g., read only memory (ROM) 706 and random access memory (RAM) 708), to the processor 730. The system 700 can include a cache of high-speed memory connected directly with, in close proximity to, or integrated as part of the processor 730. The system 700 can copy data from the memory 704 and/or the storage device 712 to the cache 728 for quick access by the processor 730. In this way, the cache can provide a performance boost for processor 730 while waiting for data. These and other modules can control or be configured to control the processor 730 to perform various actions. Other system memory 704 may be available for use as well. The memory 704 can include multiple different types of memory with different performance characteristics. The processor 730 can include any general purpose processor and a hardware module or software module, such as module 1 714, module 2 716, and module 3 718 embedded in storage device 712. The hardware module or software module is configured to control the processor 730, as well as a special-purpose processor where software instructions are incorporated into the actual processor design. The processor 730 may essentially be a completely self-contained computing system, containing multiple cores or processors, a bus, memory controller, cache, etc. A multi-core processor may be symmetric or asymmetric.

To enable user interaction with the computing device 700, an input device 720 is provided as an input mechanism. The input device 720 can comprise a microphone for speech, a touch-sensitive screen for gesture or graphical input, keyboard, mouse, motion input, and so forth. In some instances, multimodal systems can enable a user to provide multiple types of input to communicate with the system 700. In this example, an output device 722 is also provided. The communications interface 724 can govern and manage the user input and system output.

Storage device 712 can be a non-volatile memory to store data that are accessible by a computer. The storage device 712 can be magnetic cassettes, flash memory cards, solid state memory devices, digital versatile disks, cartridges, random access memories (RAMs) 608, read only memory (ROM) 706, and hybrids thereof.

The controller 710 can be a specialized microcontroller or processor on the system 700, such as a BMC (baseboard management controller). In some cases, the controller 710 can be part of an Intelligent Platform Management Interface (IPMI). Moreover, in some cases, the controller 710 can be embedded on a motherboard or main circuit board of the system 700. The controller 710 can manage the interface between system management software and platform hardware. The controller 710 can also communicate with various system devices and components (internal and/or external), such as controllers or peripheral components, as further described below.

The controller 710 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 710 to initiate or conduct specific hardware recovery procedures or operations, as further described below.

The controller 710 can also include a system event log controller and/or storage for managing and maintaining events, alerts, and notifications received by the controller 710. For example, the controller 710 or a system event log controller can receive alerts or notifications from one or more devices and components, and maintain the alerts or notifications in a system event log storage component.

Flash memory 732 can be an electronic non-volatile computer storage medium or chip that can be used by the system 700 for storage and/or data transfer. The flash memory 732 can be electrically erased and/or reprogrammed. Flash memory 732 can include EPROM (erasable programmable read-only memory), EEPROM (electrically erasable programmable read-only memory), ROM, NVRAM, or CMOS (complementary metal-oxide semiconductor), for example. The flash memory 732 can store the firmware 734 executed by the system 700 when the system 700 is first powered on, along with a set of configurations specified for the firmware 734. The flash memory 732 can also store configurations used by the firmware 734.

The firmware 734 can include a Basic Input/Output System or equivalents, such as an EFI (Extensible Firmware Interface) or UEFI (Unified Extensible Firmware Interface). The firmware 734 can be loaded and executed as a sequence program each time the system 700 is started. The firmware 734 can recognize, initialize, and test hardware present in the system 700 based on the set of configurations. The firmware 734 can perform a self-test, such as a POST (Power-on-Self-Test), on the system 700. This self-test can test the functionality of various hardware components such as hard disk drives, optical reading devices, cooling devices, memory modules, expansion cards, and the like. The firmware 734 can address and allocate an area in the memory 704, ROM 706, RAM 708, and/or storage device 712, to store an operating system (OS). The firmware 734 can load a boot loader and/or OS, and give control of the system 700 to the OS.

The firmware 734 of the system 700 can include a firmware configuration that defines how the firmware 734 controls various hardware components in the system 700. The firmware configuration can determine the order in which the various hardware components in the system 700 are started. The firmware 734 can provide an interface, such as an UEFI, that allows a variety of different parameters to be set, which can be different from parameters in a firmware default configuration. For example, a user (e.g., an administrator) can use the firmware 734 to specify clock and bus speeds; define what peripherals are attached to the system 700; set monitoring of health (e.g., fan speeds and CPU temperature limits); and/or provide a variety of other parameters that affect overall performance and power usage of the system 700. While firmware 734 is illustrated as being stored in the flash memory 732, one of ordinary skill in the art will readily recognize that the firmware 734 can be stored in other memory components, such as memory 704 or ROM 706.

System 700 can include one or more sensors 726. The one or more sensors 726 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 726 can communicate with the processor, cache 728, flash memory 732, communications interface 724, memory 704, ROM 706, RAM 708, controller 710, and storage device 712, via the bus 702, for example. The one or more sensors 726 can also communicate with other components in the system via one or more different means, such as inter-integrated circuit (I2C), general purpose output (GPO), and the like. Different types of sensors (e.g., sensors 726) on the system 700 can also report to the controller 710 on parameters, such as cooling fan speeds, power status, operating system (OS) status, hardware status, and so forth. A display 736 may be used by the system 700 to provide graphics related to the applications that are executed by the controller 710, or the processor 730.

FIG. 8 illustrates an example computer system 800 having a chipset architecture that can be used in executing the described method(s) or operations, and generating and displaying a graphical user interface (GUI). Computer system 800 can include computer hardware, software, and firmware that can be used to implement the disclosed technology. System 800 can include a processor 810, representative of a variety of physically and/or logically distinct resources capable of executing software, firmware, and hardware configured to perform identified computations. Processor 810 can communicate with a chipset 802 that can control input to and output from processor 810. In this example, chipset 802 outputs information to output device 814, such as a display, and can read and write information to storage device 816. The storage device 816 can include magnetic media, and solid state media, for example. Chipset 802 can also read data from and write data to RAM 818. A bridge 804 for interfacing with a variety of user interface components 806, can be provided for interfacing with chipset 802. User interface components 806 can include a keyboard, a microphone, touch detection and processing circuitry, and a pointing device, such as a mouse.

Chipset 802 can also interface with one or more communication interfaces 808 that can have different physical interfaces. Such communication interfaces can include interfaces for wired and wireless local area networks, for broadband wireless networks, and for personal area networks. Further, the machine can receive inputs from a user via user interface components 806, and execute appropriate functions, such as browsing functions by interpreting these inputs using processor 810.

Moreover, chipset 802 can also communicate with firmware 812, which can be executed by the computer system 800 when powering on. The firmware 812 can recognize, initialize, and test hardware present in the computer system 800 based on a set of firmware configurations. The firmware 812 can perform a self-test, such as a POST, on the system 800. The self-test can test the functionality of the various hardware components 802-818. The firmware 812 can address and allocate an area in the RAM memory 818 to store an OS. The firmware 812 can load a boot loader and/or OS, and give control of the system 800 to the OS. In some cases, the firmware 812 can communicate with the hardware components 802-810 and 814-818. Here, the firmware 812 can communicate with the hardware components 802-810 and 814-818 through the chipset 802, and/or through one or more other components. In some cases, the firmware 812 can communicate directly with the hardware components 802-810 and 814-818.

It can be appreciated that example systems 700 and 800 can have more than one processor (e.g., 730, 810), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above-described embodiments. Rather, the scope of the invention should be defined in accordance with the following claims and their equivalents.

What is claimed is:

1. A system evaluating and recommending financial products for a customer, the system comprising:
a question set manager generating a plurality of questions related to financial needs of the customer and collects answers to the plurality of questions;
a memory storing a plurality of financial products, each of the financial products having a set of parameters;
an analysis engine determining a desirability score for each of the plurality of financial products determined by the collected answers to the displayed questions in relation to the parameters; and
a recommendation engine outputting a ranking of the plurality of financial products by the determined score.

2. The system of claim 1, further comprising an application programing interface (API) allowing interface to a computing device operated by the consumer, wherein the API allows interface to different devices and operating systems.

3. The system of claim 2, wherein the API allows access to an application executed on the computing device to display the questions on the device.

4. The system of claim 2, wherein the recommendation engine outputs a recommendation based on the ranking of the plurality of financial products.

5. The system of claim 2, wherein the recommendation engine outputs an explanation of the recommended products.

6. The system of claim 3, wherein the application presents the plurality of questions as a single display of the questions.

7. The system of claim 3, wherein the application presents each of the plurality of questions singularly, wherein an answer received allows the next question to be displayed.

8. The system of claim 4, wherein the application displays an input to allow an application for the recommended financial product.

9. The system of claim 1, wherein the financial products are loan programs and the parameters include interest rate and income.

10. A method to evaluate and recommend financial products for a customer, the method comprising:
generating a set of interfaces to receive a plurality of questions related to financial needs of the customer and collect answers to the plurality of questions;
storing a plurality of financial products, each of the financial products having a set of parameters;
determining a desirability score for each of the plurality of financial products determined by the collected answers to the displayed questions in relation to the parameters; and
outputting a ranking of the plurality of financial products by the determined score.

11. The method of claim 10, wherein an application programing interface (API) interfaces to a computing device operated by a customer, wherein the API allows interface to different devices and operating systems.

12. The method of claim 11, further comprising accessing an application executed on the computing device to present the questions on the device.

13. The method of claim 12, further comprising outputting a recommendation based on the ranking of the plurality of financial products.

14. The method of claim 11, further comprising outputting an explanation of the recommended products.

15. The method of claim 14, wherein the application presents the plurality of questions as a single display of the questions.

16. The method of claim 14, wherein the application presents each of the plurality of questions singularly, wherein an answer received allows the next question to be displayed.

17. The method of claim 14, wherein the application displays an input to allow an application for the recommended financial product.

18. The method of claim 11, wherein the financial products are loan programs and the parameters include interest rate and income.

19. A non-transitory computer-readable medium having machine-readable instructions stored thereon, which when executed by a processor, cause the processor to:
generate a set of interfaces to display a plurality of questions related to financial needs of the customer and collect answers to the plurality of questions;
store a plurality of financial products, each of the financial products having a set of parameters;
determine a desirability score for each of the plurality of financial products determined by the collected answers to the displayed questions in relation to the parameters; and
output a ranking of the plurality of financial products by the determined score.

20. The non-transitory computer-readable medium of claim 19, wherein the machine-readable instructions are an application programing interface (API) allows interface to different devices and operating systems.
